(19) United States
(12) Patent Application Publication
(10) Pub. No.: US 2010/0195035 A1
(43) Pub. Date: Aug. 5, 2010

(54) LIQUID CRYSTAL PANEL, LIQUID CRYSTAL DISPLAY DEVICE, TELEVISION RECEIVER AND MANUFACTURING METHOD OF LIQUID CRYSTAL PANEL

(76) Inventor: Shinichi Hirato, Osaka (JP)

Correspondence Address: NIXON & VANDERHYE, PC, 901 NORTH GLEBE ROAD, 11TH FLOOR, ARLINGTON, VA, 22203, US

(21) Appl. No.: 12/679,569

(22) PCT Filed: Jun. 9, 2008
(86) PCT No.: PCT/JP2008/060519

§ 371 Date: Mar. 23, 2010

(30) Foreign Application Priority Data
Sep. 26, 2007 (JP) 2007-249548

(51) Int. Cl. G02F 1/1337; G02F 1/13

(52) U.S. Cl. 349/124; 349/123; 349/187

(57) ABSTRACT

A liquid crystal panel 10 includes a pair of substrates 17, 18, which are arranged to face each other so that a gap of a predetermined size is maintained therebetween. Further included are a liquid crystal layer 19 enclosed between the substrates 17, 18, a spacer 21 arranged in the liquid crystal layer 19 to maintain the gap between the substrates 17, 18, and an anchoring layer 33 arranged to fix the spacer 21 to the array substrate 18, i.e., to one of the substrates 17, 18. The liquid crystal panel 10 further includes an alignment film 27 for orientational alignment of liquid crystal molecules included in the liquid crystal layer 19. The alignment film 27 is arranged on the surface of the array substrate 18 facing the CF substrate 17, so as to surround and cover the spacer 21 and the anchoring layer 33.

### TECHNICAL FIELD

The present invention relates to a liquid crystal panel, a liquid crystal display device, a television receiver and a manufacturing method of a liquid crystal panel.

### BACKGROUND ART

A liquid crystal panel as a component of a liquid crystal display device generally has a construction that includes a pair of substrates, which are arranged to face each other so that a gap of a predetermined size is maintained therebetween. A liquid crystal layer is provided between the substrates, so as to be sealed by the surrounding sealant. Further, spacers are provided to maintain the gap between the substrates.

According to a known method of arranging spacers, a number of spacer particles are dispersed in a pre-selected solvent, and the spacer-dispersed solvent is sprayed onto a planar surface of a substrate. According to the method, however, the spacers on the planar surface of the substrate may be located at the areas corresponding to the pixels, which can cause light escape or orientational defects in the liquid crystal.

In view of this, an ink-jet apparatus is used nowadays in order to locate spacer particles at predetermined areas such as light blocking areas of the substrate. A method described in Patent Document 1 below is known, for example. According to the method, ter the formation of alignment films on respective substrates having TFTs, various wiring lines, pixel electrodes and a color filter formed thereon, spacers are applied thereto by an ink-jet apparatus so as to be located at predetermined positions. Thereafter, the substrates are attached to each other so that a liquid crystal layer is enclosed therebetween.

Even if the spacers are once arranged as above, the unfixed spacers on the substrate may be displaced to light transmitting areas at the time of the subsequent injection of a liquid crystal material for the liquid crystal layer. In this connection, Patent Document 2 below describes a method for preventing the displacement of the spacers. According to the method, an anchoring layer made of a thermoplastic resin is preliminarily provided on each spacer. After the spacers are arranged at the predetermined positions, the anchoring layers are softened by heat and are subsequently cooled, resulting in fixation of the spacers on the substrate.

### Patent Document 1: JP-A-2004-37855

### Patent Document 2: JP-A-2002-327030

### Problem to be Solved by the Invention

As described above, the conventional method provides spacers after the formation of an alignment film, and therefore the spacers are arranged and fixed on the alignment film. Thereafter, a liquid crystal layer is provided thereon. The resultant structure can have the following problems, however. During the provision of the liquid crystal layer, the anchoring layers may be re-softened when the substrates are heated for hardening the sealant that is provided at the peripheral areas of the substrates for sealing the liquid crystal layer, for example. Further, after the completed liquid crystal panel is united with a backlight, the anchoring layers may be also re-softened due to the heat generated by the lighted backlight, for example. The resoftening of the anchoring layers can cause some problems, such as displacement of spacers on the substrate or contamination of the liquid crystal layer due to seepage of the re-softened anchoring layers into the liquid crystal layer. These problems can lead to reduction in quality of display.

### DISCLOSURE OF THE INVENTION

The present invention was made in view of the foregoing circumstances, and an object thereof is to prevent reduction in quality of display.

### Means for Solving the Problem

A liquid crystal panel according to the present invention includes a pair of substrates, which are arranged to face each other so that a gap of a predetermined size is maintained therebetween. Further included are a liquid crystal layer enclosed between the substrates, a spacer arranged in the liquid crystal layer to maintain the gap between the substrates, and an anchoring layer arranged to fix the spacer to one of the substrates. The liquid crystal panel further includes an alignment film for orientational alignment of liquid crystal molecules included in the liquid crystal layer. The alignment film is arranged on the surface of the one of the substrates facing the other of the substrates, so as to surround and cover the spacer and the anchoring layer.

In the present liquid crystal panel, the spacer is fixed to the one of the substrates via the anchoring layer, and further the alignment film is provided on the one of the substrates so as to surround and cover the spacer and the anchoring layer, as described above. According to the construction, even when the anchoring layer is re-softened, the spacer can be prevented from displacement by the surrounding alignment film. Further, the anchoring layer can be prevented from seeping into the liquid crystal layer, also due to the surrounding alignment film.

According to some aspects of the present invention, the following preferable constructions are provided for a liquid crystal panel.

(1) The anchoring layer can be formed of a thermoplastic material. According to the construction, the fixation of the spacer to the one of the substrates can be achieved by heating the anchoring layer. Even if heat is applied after the fixation of the spacer, the displacement of the spacer and the seepage of the anchoring layer into the liquid crystal layer can be both prevented by the alignment film covering the spacer and the anchoring layer.
(2) The alignment film may be formed of a photoreactive material so that a surface thereof can become anisotropic by light irradiation. According to the construction, the surface of the alignment film can be made anisotropic by a noncontact method. In the case that the alignment film should undergo a rubbing process, for example, the spacer covered with the alignment film may be displaced during the rubbing process. In contrast, the displacement can be prevented according to the present construction.
(3) The liquid crystal molecules included in the liquid crystal layer may be provided to be oriented in the direction substantially perpendicular to the surface of the alignment film. Further, an uneven portion may be provided on a surface of at least one of the substrates so as to control the orientational state of the liquid crystal molecules included in the liquid crystal layer. According to the construction, the alignment film is not required to undergo an orientational alignment process such as a rubbing process. In the case that the alignment film should undergo a rubbing process, for example, the spacer covered with the alignment film may be displaced during the rubbing process. In contrast, the displacement can be prevented according to the present construction.
(4) The spacer can be arranged at a light blocking area on at least one of the substrates. The present construction enables prevention of light escape caused by the spacer, resulting in a high quality of display.

In order to solve the above problem, a liquid crystal display device according to the present invention includes a liquid crystal panel described above, and a lighting device capable of illuminating the liquid crystal panel.

The present liquid crystal display device can have a high quality of display, because the displacement of the spacer and the seepage of the anchoring layer into the liquid crystal layer are prevented in the liquid crystal panel provided for image display The liquid crystal display device has a variety of applications, such as a television display or a personal-computer display. Particularly, it is suitable for a large screen display.

In order to solve the above problem, the present invention provides a manufacturing method of a liquid crystal panel having a pair of substrates arranged to face each other so that a gap of a predetermined size is maintained therebetween; a liquid crystal layer enclosed between the pair of substrates; a spacer arranged in the liquid crystal layer to maintain the gap between the substrates; and an alignment film provided for orientational alignment of liquid crystal molecules included in the liquid crystal layer. The manufacturing method includes a spacer setting process for arranging the spacer on one of the substrates. The spacer has a surrounding anchoring layer. The manufacturing method further includes a spacer fixing process for temporarily softening the anchoring layer so that the spacer is fixed to the one of the substrates, an alignment-film forming process for applying the alignment film to a surface of the one of the substrates so that the alignment film surrounds and covers the spacer and the anchoring layer, and a substrate attachment process for attaching the substrates to each other so that the liquid crystal layer is enclosed between the substrates.

According to the present method for the liquid crystal panel, the application of the alignment film is made after the spacer is fixed to the one of the substrates via the anchoring layer. Therefore, the alignment film can reliably surround and cover the spacer and the anchoring layer. Consequently, the spacer is reliably prevented from displacement, and the anchoring layer is reliably prevented from seeping into the liquid crystal layer.

According to some aspects of the present invention, the following preferable constructions are provided for a manufacturing method of a liquid crystal panel.

(1) The spacer arranged by the spacer setting process may have an anchoring layer formed of a thermoplastic material as the above anchoring layer, and the anchoring layer can be heated by the spacer fixing process. According to the method, the spacer can be readily fixed on the one of the substrates.
(2) An ink-jet apparatus may be used to arrange the spacer during the spacer setting process. Thereby, the spacer can be arranged at a predetermined position.
(3) An ink-jet apparatus may be used to apply the alignment film during the alignment-film forming process. According to the method, the application of the alignment film can be achieved without generating a force to displace the spacer, which has been fixed on the one of the substrates by the spacer fixing process. That is, the casual displacement of the spacer can be prevented.

### EFFECT OF THE INVENTION

The present invention can prevent reduction in quality of display.

### BRIEF DESCRIPTION OF THE DRAWINGS

FIG. 1 is an exploded view showing an overview of a television receiver according to an embodiment 1 of the present invention;

FIG. 2 is a sectional view showing an overview of a liquid crystal display device;

FIG. 3 is an enlarged plan view of an array substrate included in a liquid crystal panel;

FIG. 4 is an enlarged sectional view of a part of the liquid crystal panel, which corresponds to the central area of the screen;

FIG. 5 is a side view showing an overview of an operation for applying spacers or an alignment film by using an ink-jet apparatus;

FIG. 6 is an enlarged plan view of the array substrate when ink including spacers has landed at gate wiring lines;

FIG. 7 is an enlarged sectional view showing the ink including spacers, which has landed at the gate wiring line;

FIG. 8 is an enlarged sectional view showing when the ink has been volatilized;

FIG. 9 is an enlarged sectional view showing when the spacers are fixed as a result of melting and solidification of anchoring layers;

FIG. 10 is an enlarged sectional view showing when application and leveling of an alignment film have been completed;

FIG. 11 is an enlarged sectional view showing when drying of the alignment film after the application has been completed; and

FIG. 12 is a sectional view of a liquid crystal panel according to an embodiment 2 of the present invention.

### EXPLANATION OF SYMBOLS

10: Liquid crystal panel, 11: Backlight (Lighting device), 17: CF substrate (Substrate, The other of substrates), 18: Array substrate (Substrate, One of substrates), 19: Liquid crystal layer, 19a: Liquid crystal molecules, 20: Sealant portion, 21: Spacer, 24: Gate wiring line (Light blocking area), 27, 31: Alignment film, 33: Anchoring layer, 34: Rib (Uneven portion), 40: Ink-jet apparatus, D: Liquid crystal display device, TV: Television receiver.

### BEST MODE FOR CARRYING OUT THE INVENTION

### Embodiment 1

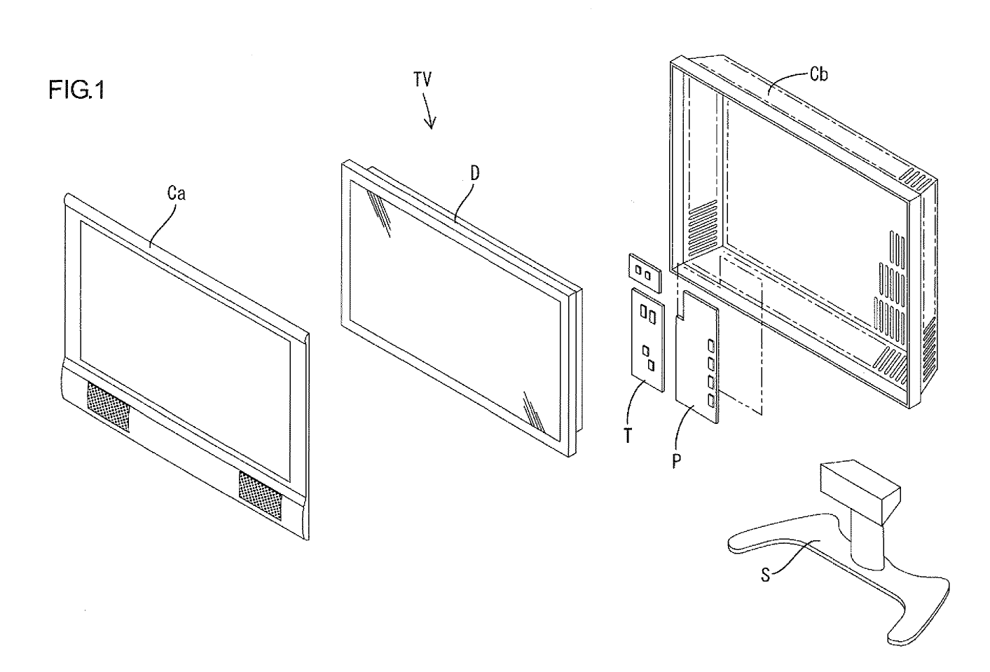

An embodiment 1 according to the present invention will be explained with reference to FIGS. 1 to 11. In the present embodiment, a liquid crystal panel 10 included in a liquid crystal display device D will be illustrated.

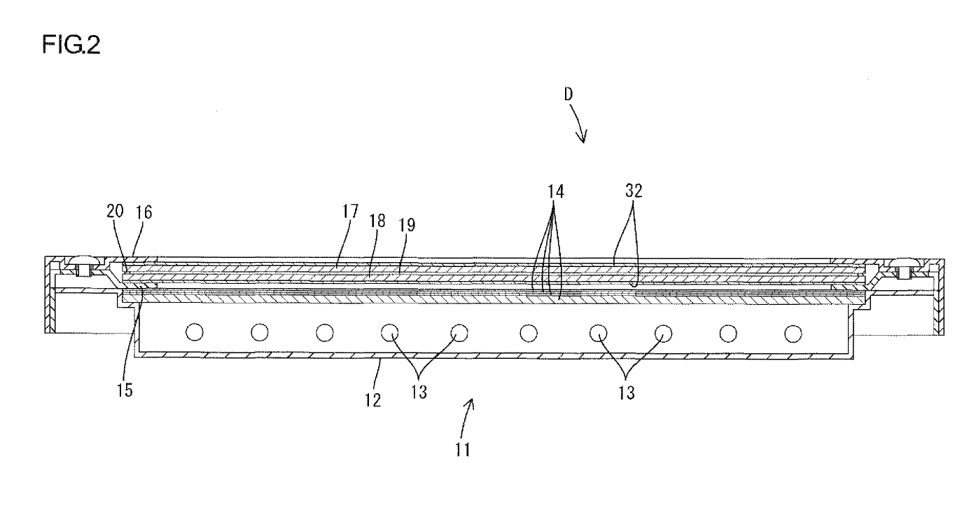

Referring to FIG. 2, the liquid crystal display device D forms a horizontally-long rectangular shape as a whole, which includes the liquid crystal panel 10 as a display panel capable of image display and further includes a backlight 11 that is disposed on the rear side (or back-surface side) of the liquid crystal panel 10 as an external light source (or a lighting device) capable of illuminating the liquid crystal panel 10. The liquid crystal display device D can be applied to a television receiver TV. As shown in FIG. 1, the television receiver TV includes the liquid crystal display device D, and front and back cabinets Ca and Cb capable of holding the liquid crystal display device D therebetween. Further included are a power source P, a tuner T for broadcast reception such as TV reception, and a stand S.

The backlight 11 will be briefly explained first. Referring to FIG. 2, the backlight 11 includes a casing 12 having a substantially box-like shape with a front-side (i.e., liquid crystal panel 10 side) opening, a plurality of linear light sources 13 (e.g., cold cathode tubes) arranged parallel to one another in the casing 12, a plurality of optical members 14 arranged in a stack (e.g., a diffuser plate, a diffusing sheet, a lens sheet and a brightness enhancement sheet, arranged in this order from the back side) in the opening of the casing 12, and a rectangular-shaped frame 15 for holding the optical members 14 together with the casing 12 and therebetween. The optical members 14 have functions such as a function for converting light from each linear light source 13 into flat light. The frame 15 can function also as a support member for supporting the liquid crystal panel 10 from the back side. A frame-like bezel 16 (or a holding member) is mounted on the front side of the liquid crystal panel 10, so as to bear down on the liquid crystal panel 10. The liquid crystal panel 10 is thus held between the support member and the holding member.

Next, the liquid crystal panel 10 will be explained in detail. The liquid crystal panel 10 includes a pair of transparent (or light transmissive) glass substrates 17, 18 having a horizontally-long rectangular shape, and further includes a liquid crystal layer 19 disposed between the substrates 17, 18. The liquid crystal layer 19 includes liquid crystal molecules as a material with an optical property that changes with applied voltage. The liquid crystal panel 10 further includes a frame-like sealant portion 20 that is disposed between the substrates 17, 18 so as to surround and seal the liquid crystal layer 19. The sealant portion 20 is formed of a sealant, e.g., made of a thermoset resin material that hardens when heated, or a light curing resin material that hardens when irradiated with light (e.g., ultraviolet or visible light). The substrates 17, 18 are attached to each other so as to face each other, while a gap (or interval) of a predetermined size is kept therebetween. A number of spacers 21 are provided to scatter in the liquid crystal layer 19, so that the gap between the substrates 17, 18 is maintained. The details of the spacers 21 will be explained later.

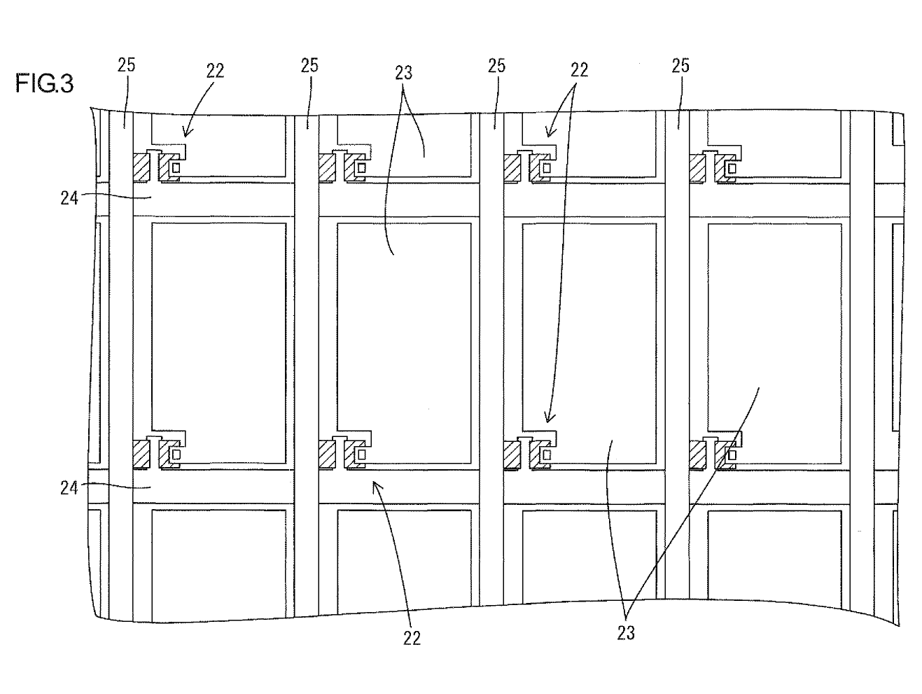

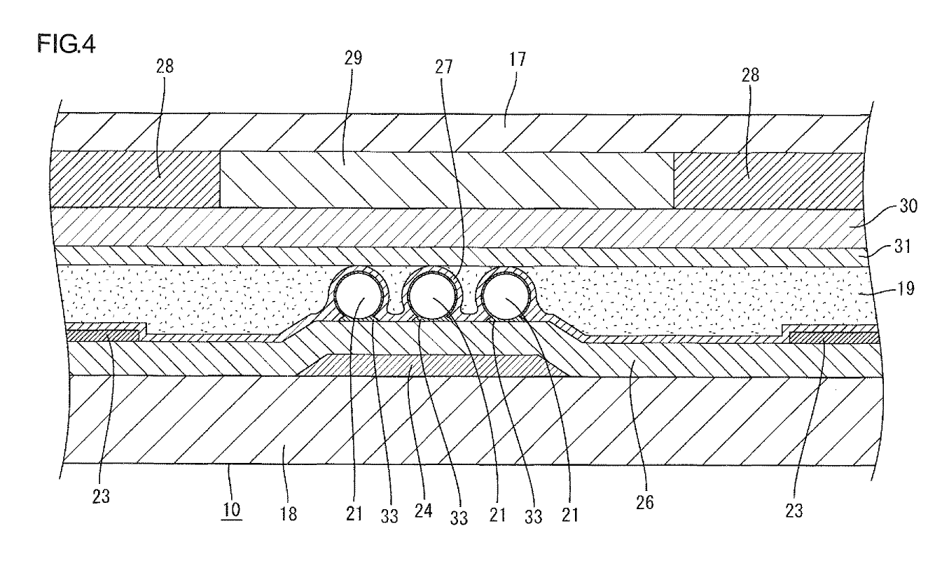

The front-side one (or obverse-side one) of the substrates 17, 18 is provided as a CF substrate 17, while the back-side one (or reverse-side one) is provided as an array substrate 18. On the inner surface side (i.e., liquid crystal layer side or CF substrate 17 facing surface side) of the array substrate 18, as shown in FIG. 3, a number of TFTs 22 (Thin Film Transistors) as switching elements and pixel electrodes 23 are arranged, and further gate wiring lines 24 and source wiring lines 25 are arranged in a grid pattern so as to surround the TFTs 22 and the pixel electrodes 23. The pixel electrode 23 is connected to the drain electrode of the TFT 22. The source wiring line 25 is connected to the source electrode of the TFT 22, while the gate wiring line 24 is connected to the gate electrode of the TFT 22. Each pixel electrode 23 is formed of a transparent electrode, e.g., made of ITO (Indium Tin Oxide) or ZnO (Zinc Oxide). As shown in FIG. 4, an insulating layer 26 is provided on the surfaces of the array substrate 18 and the gate wiring lines 24. The pixel electrodes 23 are provided on the surface of the insulating layer 26. Further, an alignment film 27 for orientational alignment of the liquid crystal molecules included in the liquid crystal layer 19 is provided on the surfaces of the pixel electrodes 23 and the insulating layer 26. The details of the alignment film 27 thus provided on the array substrate 18 side will be explained later.

On the other hand, as shown in FIG. 4, a number of colored films 28 constituting a color filter are arranged on the CF substrate 17 so as to correspond to the respective pixels. The color filter includes colored films 28 of three colors, i.e., R, G and B which are arranged in cyclic order. A light blocking layer 29 (black matrix) for preventing color mixture is provided between the colored films 28 of the color filter. A counter electrode 30 is provided on the surfaces of the light blocking layer 28 and the light blocking layer 29, so as to be opposite to the pixel electrodes 23 provided on the array substrate 18 side. An alignment film 31 for orientational alignment of the liquid crystal molecules included in the liquid crystal layer 19 is provided on the surface of the counter electrode 30. Further, a pair of front and back polarizing plates 32 are attached on the outer surface sides of the respective substrates 17, 18, as shown in FIG. 2.

Hereinafter, the spacers 21 and the alignment film 27 provided on the array substrate 18 side will be explained in detail. The spacers 21 are made of an organic material such as phenolic resin or epoxy resin, or alternatively, made of an inorganic material such as silica. Referring to FIG. 4, each spacer 21 has a substantially spherical shape, and is fixed to the surface of the array substrate 18 via an anchoring layer 33 made of a thermoplastic resin material. The anchoring layer 33 is disposed between the bottom area of the outer surface of the spacer 21 (i.e., the area facing the array substrate 18) and the surface of the insulating layer 26 on the array substrate 18, so as to adhere firmly to the both 21, 26. The spacers 21 are located on the array substrate 18 so as to be above the gate wiring lines 24 and therefore at the light blocking areas. In consequence, the spacers 21 are located below the light blocking layer 29 and therefore at the light blocking areas of the CF substrate 17. The anchoring layers 33 prevent the respective spacers 21 from being displaced from the light blocking areas. The anchoring layers 33, which are made of a thermoplastic resin material, have a softening temperature (or melting point) in the range 40-120 degrees C. In order to achieve high adhesion to the array substrate 18, it is preferable to be in the range 40-70 degrees C.

The alignment film 27 is provided to extend substantially over the area of the array substrate 18 corresponding to the image display area (i.e., the active area or the area that is provided on the inner side of the sealant portion 20 so as to correspond to the liquid crystal layer 19). The alignment film 27 covers the pixel electrodes 23 and the insulating layer 26, and further covers or surrounds the spacers 21 and the anchoring layers 33. Specifically, the spacers 21 and the anchoring layers 33 are completely covered with the alignment film 27. According to the construction, the spacers 21, which are fixed to the array substrate 18 by the anchoring layers 33, can be held on the array substrate 18 by the alignment film 27. Further, the anchoring layers 33 are prevented from being directly exposed to the liquid crystal layer 19.

The alignment film 27 is formed of a photoreactive material, and therefore the surface thereof can become anisotropic when irradiated with light polarized in a predetermined direction. For example, a polymer containing polyimide with a photoreactive end group can be used as the above photoreactive material, and polarized ultraviolet can be used as the irradiation light. The surface of the alignment film 27, which has been subjected to an optical alignment process as above, can induce the orientational alignment of the liquid crystal molecules included in the liquid crystal layer 19 faced with the surface of the alignment film 27.

Next, a manufacturing method of a liquid crystal panel 10 having the above construction will be explained. A brief explanation is as follows: The manufacture of the liquid crystal panel 10 includes a CF substrate treatment process for forming components on a surface of a CF substrate 17, an array substrate treatment process for forming components on a surface of an array substrate 18, and a substrate attachment process for attaching the completed substrates 17, 18 to each other. In the CF substrate treatment process, a color filter (or specifically, colored films 28), a light blocking layer 29, a counter electrode 30 and an alignment film 31 are formed on the surface of the CF substrate 17, in a known manner. In the array substrate treatment process, TFTs 22, pixel electrodes 23, gate wiring lines 24, source wiring lines 25 and an insulating layer 26 are first formed on the surface of the array substrate 18, in a known manner. The array substrate treatment process further includes a spacer setting process for arranging spacers 21 thereon, a spacer fixing process for fixing the spacers 21, and an alignment-film forming process for forming an alignment film 27 thereon, which are to be performed sequentially. Hereinafter, the spacer setting process, the spacer fixing process and the alignment-film forming process will be explained in detail.

During the array substrate treatment process, specifically, the spacers 21 are arranged (by the spacer setting process) after the formation of the pixel electrodes 23 and the insulating layer 26 (but before the formation of the alignment film 27). In the spacer setting process, the spacers 21 are arranged on the array substrate 18 using an ink-jet apparatus 40, so as to be located at predetermined positions.

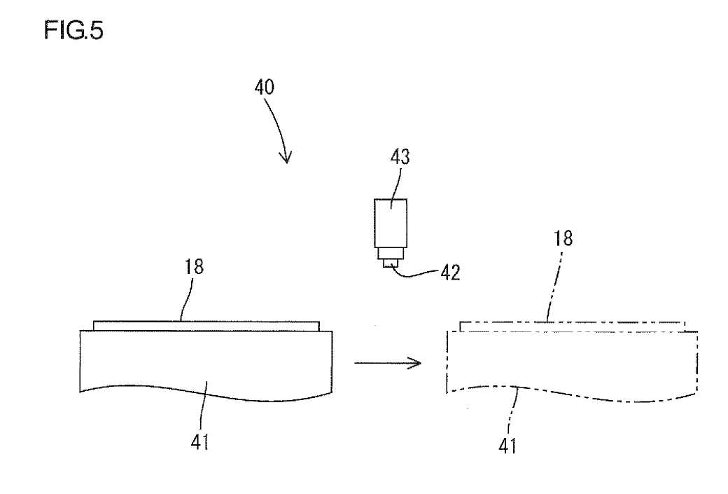

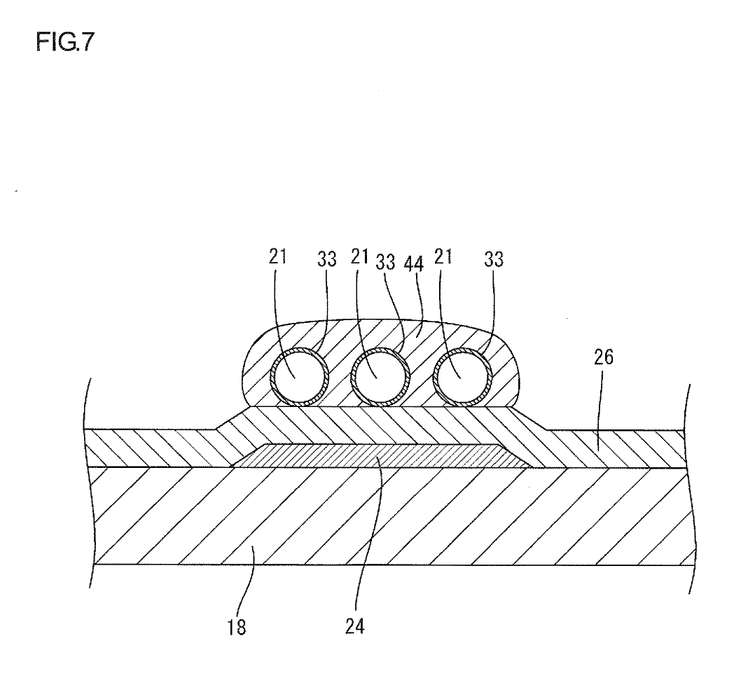

Referring to FIG. 5, the ink-jet apparatus 40 includes a stage 41 on which the array substrate 18 can be placed, and further includes a nozzle head 43 having a number of serially-arranged nozzles 42. The stage 41 can be moved relative to the nozzle head 43 by a stage drive unit not shown. The nozzle head 43 is connected with a tank that contains ink 44 including a predetermined density of spacers 21, and a predetermined amount of ink can be supplied at a time by a pump (although both of the tank and the pump are not shown). The nozzles 42 are arranged on the nozzle head 43 at intervals corresponding to the intervals between gate wiring lines 24. The ink 44 is formed of a volatile solvent. The outer surface of each spacer 21 included in the ink 44 is covered with an anchoring layer 33 that has a substantially uniform thickness (See FIG. 7).

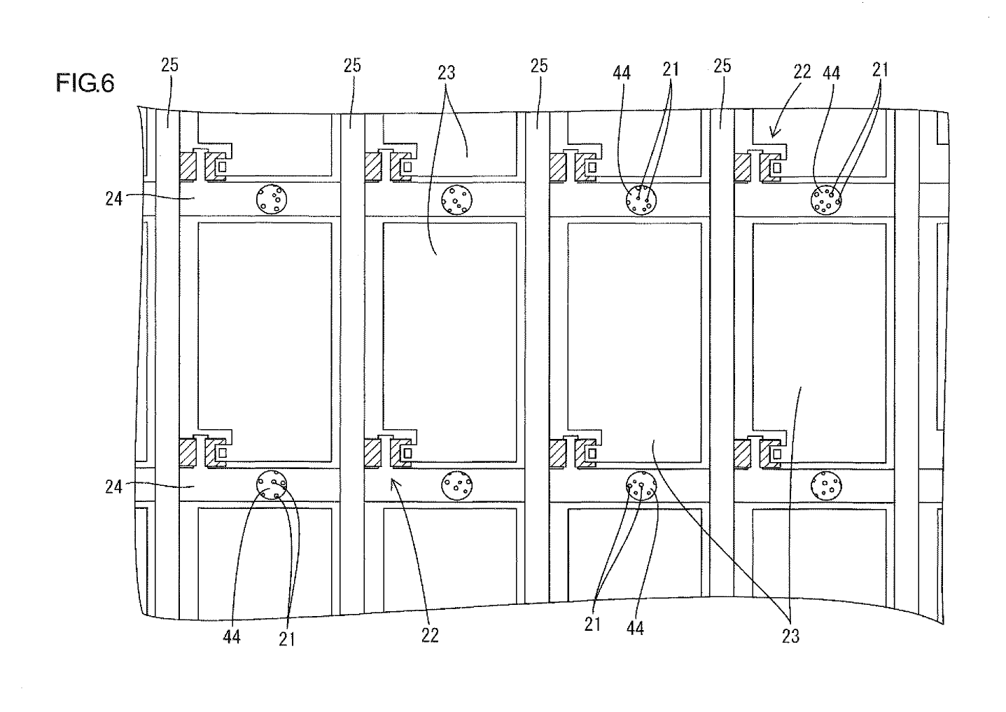

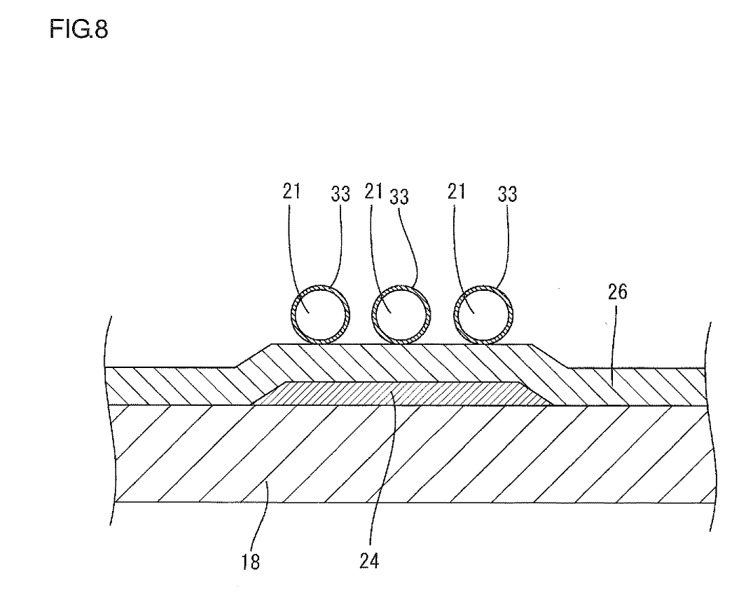

The array substrate 18 is placed on the stage 41, and the nozzles 42 are positioned with respect to the array substrate 18 so as to be aligned with the gate wiring lines 24. While the stage 41 is moved relative to the nozzle head 43, droplets of the ink 44 are ejected from the nozzles 42 sequentially at predetermined times. The ejected droplets of the ink 44 can land at the gate wiring lines 24 corresponding to the light blocking areas, as shown in FIGS. 6 and 7. At the time, the number of droplets of the ink 44 per pixel electrode 23 can be adjusted by the adequate adjustment of the ejection timing (FIG. 6 shows when one droplet of the ink 44 is provided for each pixel electrode 23). The array substrate 18, on which the ink 44 including the spacers 21 has been arranged, is dried in a predetermined temperature environment, so that the ink 44 surrounding the spacers 21 is volatilized or removed as shown in FIG. 8.

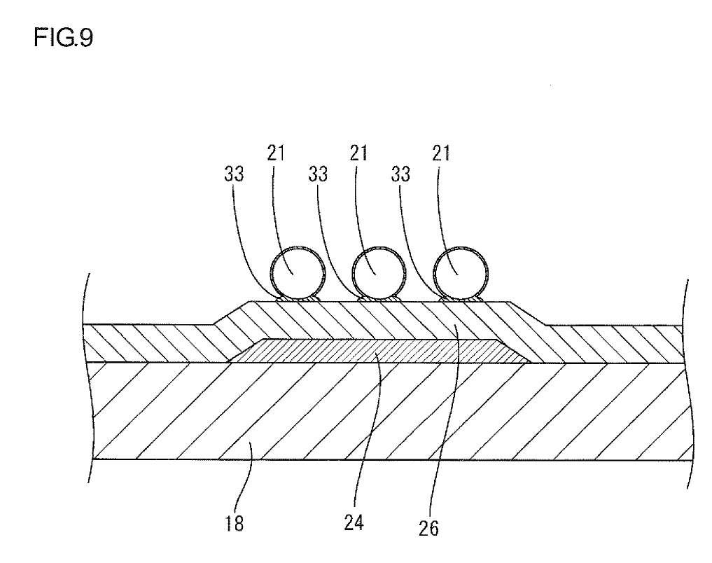

Next, the spacer fixing process is performed. In the process, the array substrate 18 is baked for a predetermined length of time so that the anchoring layers 33 are heated to the softening temperature. Thereby, the anchoring layers 33 surrounding the spacers 21 are temporarily melted (or softened), and flow to the bottom sides of the spacers 21, i.e., flow in between the spacers 21 and the array substrate 18, as shown in FIG. 9. The array substrate 18 is then cooled so that the anchoring layers 33 between the spacers 21 and the array substrate 18 are solidified (or hardened). Consequently, the spacers 21 are fixed to the array substrate 18 via the anchoring layers 33 so that the displacement is prevented.

The alignment-film forming process is subsequently performed. In the process, an alignment film 27 is formed on the array substrate 18 by using an ink-jet apparatus 40 similar to that used in the above spacer setting process. The ink-jet apparatus 40 to be used in the present process has substantially the same construction as the above ink-jet apparatus, except that a solvent (e.g., a solvent including a ketonic group) having a predetermined density of alignment film material (e.g., polyimide) is used as ink 44. Therefore, the components are designated by the same symbols, and the redundant explanations are omitted.

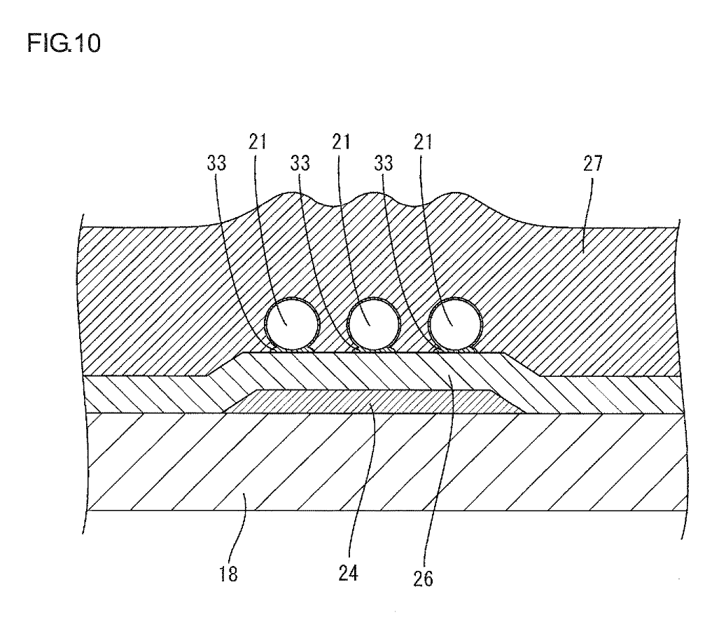

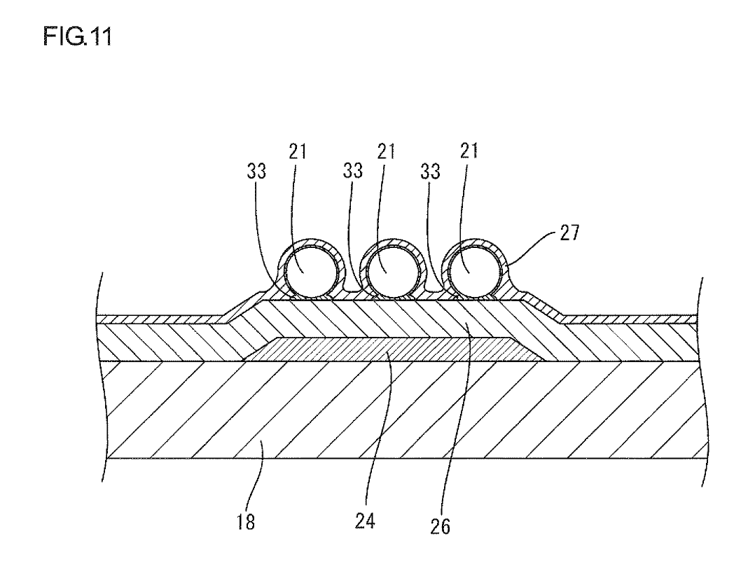

Referring to FIG. 5, the array substrate 18 is placed on the stage 41, and thereafter droplets of the ink 44 are ejected from the nozzles 42 sequentially at predetermined times while the stage 41 is moved relative to the nozzle head 43. Thereby, the alignment film material is applied to the array substrate 18. After the material ejection, the array substrate 18 is left for a predetermined length of time (for leveling purposes). Consequently, the droplets of the ink 44 having landed at predetermined positions extend on the surface of the array substrate 18 so as to connect to one another. Thus, a film of the ink 44 having a substantially uniform thickness (See FIG. 10) can be formed to have no defects (i.e., not to have holes in places). After the subsequent prebake at a relatively low temperature, the array substrate 18 is postbaked at a relatively high temperature so that the solvent of the ink 44 is volatilized. Thus, the alignment film 27 is completed. As shown in FIG. 11, the completed alignment film 27 can cover the spacers 21 and the peripheries of the anchoring layers 33, as well as the insulating layer 26 and pixel electrodes 23 on the array substrate 18. Note that the intervals between the nozzles 42 arranged on the nozzle head 43 and/or the amount of the ink 44 to be ejected in droplets from each nozzle 42 can be set arbitrarily and appropriately.

A process for orientational alignment of the surface of the completed alignment film 27 is subsequently performed. Specifically, the surface of the alignment film 27 is irradiated with light polarized in a predetermined direction, such as polarized ultraviolet. Thereby, the surface of the alignment film 27 becomes anisotropic so as to be able to induce the orientational alignment of the liquid crystal molecules. Then, the treatment of the array substrate 18 is completed.

Next, the substrate attachment process is performed for attaching the CF substrate 17 completed via the CF substrate treatment process and the array substrate 18 completed via the array substrate treatment process to each other (Note that the CT substrate has an alignment film 31 having undergone an orientational alignment process as in the case of the array substrate 18). In the substrate attachment process, a sealant portion 20 is first formed (by a sealant-portion forming process) on the array substrate 18 (or alternatively, on the CF substrate 17). Thereafter, in order to form a liquid crystal layer 19, a liquid crystal material is dropped (by a liquid crystal dispensing process) on the array substrate 18, or specifically, on the area provided on the inner side of the sealant portion 20. The CF substrate 17 is attached to the array substrate 18 having the liquid crystal thereon. Consequently, the liquid crystal layer 19 is provided to be enclosed between the substrates 17, 18. On the resultant structure, the sealant portion 20 is hardened so that the substrates 17, 18 having been attached to each other as shown in FIG. 4 can be fixed. Due to the peripherally-located sealant portion 20 and the centrally-located spacers 21 provided between the substrates 17, 18, a gap of a predetermined size can be maintained therebetween.

In order to harden the sealant portion 20, the substrates 17, 18 should be heated particularly when a UV/heat dual-curable resin material or a thermoset resin material is used as a material for the sealant portion 20. The hardening temperature for any resin material may exceed 120 degrees C., by which the anchoring layers 33 for fixing the spacers 21 on the array substrate 18 can be re-softened. The resoftening of the anchoring layers 33 can cause some problems, such as light escape attributable to displacement of the spacers 21 from the light blocking areas to the light transmitting areas (i.e., to the areas corresponding to the pixels) due to reduced retention of the spacers 21, or contamination of the liquid crystal layer 19 due to seepage of the re-softened anchoring layers 33 into the liquid crystal layer 19. Further, if the re-softened anchoring layers 33 adhere to the opposite CF substrate 17 side, the spacers 21 may disengage from the substrates 17, 18 so as to be easy to move, for example, when the substrates 17, 18 are deformed to bulge (or move away from each other) due to an external shock applied to the liquid crystal panel 10.

In view of these circumstances, according to the present embodiment, the alignment film 27 is formed after the formation of the spacers 21 and the anchoring layers 33, so that the spacers 21 and the anchoring layers 33 are surrounded or covered by the alignment film 27. According to the construction, the spacers 21 are held by the surrounding alignment film 27, so that the displacement from the light blocking areas can be prevented even when the anchoring layers 33 are re-softened. Further, the anchoring layers 33 are surrounded or covered by the alignment film so as not to be exposed to the liquid crystal layer 19. Accordingly, even when re-softened, the anchoring layers 33 can be prevented from seeping into the liquid crystal layer 19. Further, the anchoring layers 33 can avoid exposure to the opposite CF substrate 17 side, also due to the covering alignment film 27. Therefore, even when re-softened, the anchoring layers 33 are prevented from adhering to the CF substrate 17 side. Consequently, the liquid crystal panel 10 can have a high quality of display, due to the prevention of displacement of the spacers 21 to the light transmitting areas and the prevention of contamination of the liquid crystal layer 19 caused by the anchoring layers 33, described above.

After front and back polarizing plates 32 are attached to the liquid crystal panel 10 completed as above, it is united with a backlight 11 and a bezel 16. Then, the manufacture of a liquid crystal display device D is completed. In the use of the liquid crystal display device D, the liquid crystal panel 10 is subjected to the heat to be generated from the lighted backlight 11, and sometimes it is subjected to a temperature exceeding the softening temperature of the anchoring layers 33 provided for fixing the spacers 21 to the array substrate 18. In this case, the anchoring layers 33 may be re-softened as in the above case. In view of this, the alignment film 27 surrounds or covers the spacers 21 and the anchoring layers 33, as described above. Thereby, the displacement of the spacers 21 can be prevented, and further the seepage of the anchoring layers 33 into the liquid crystal layer 19 can be prevented. Consequently, the liquid crystal panel 10 can have a high quality of display.

As explained above, the liquid crystal panel 10 according to the present embodiment includes a pair of substrates 17, 18, which are arranged to face each other so that a gap of a predetermined size is maintained therebetween. Further included are a liquid crystal layer 19 enclosed between the substrates 17, 18, spacers 21 arranged in the liquid crystal layer 19 to maintain the gap between the substrates 17, 18, and anchoring layers 33 arranged to fix the respective spacers 21 to the array substrate 18, i.e., to one of the substrates 17, 18. The liquid crystal panel 10 further includes an alignment film 27 for orientational alignment of liquid crystal molecules included in the liquid crystal layer 19. The alignment film 27 is arranged on the surface of the array substrate 18 facing the CF substrate 17, so as to surround or cover the spacers 21 and the anchoring layers 33. According to the construction, even when the anchoring layers 33 are re-softened, the spacers 21 can be prevented from displacement by the surrounding alignment film 27. Further, the anchoring layers 33 can be prevented from seeping into the liquid crystal layer 19, also due to the surrounding alignment film 27. Consequently, the liquid crystal panel 10 can be prevented from reduction in quality of display.

The anchoring layers 33 are formed of a thermoplastic material. Therefore, the fixation of the spacers 21 can be achieved by heating the anchoring layers 33. Even if heat is applied after the fixation, the displacement of the spacers 21 and the seepage of the anchoring layers 33 into the liquid crystal layer 19 can be both prevented by the alignment film 27 covering the spacers 21 and the anchoring layers 33.

The alignment film 27 is formed of a photoreactive material so that a surface thereof can become anisotropic by light irradiation. Thus, the alignment film 27 has a surface that can be made anisotropic by a noncontact method. In the case that the alignment film 27 should undergo a rubbing process, for example, the spacers 21 covered with the alignment film 27 may be displaced during the rubbing process. In contrast, the displacement can be prevented according to the present embodiment.

The spacers 21 are located at the light blocking areas of the substrates 17, 18. This construction enables prevention of light escape caused by the spacers 21, resulting in a high quality of display.

According to the present embodiment, a manufacturing method of a liquid crystal panel 10 includes a spacer setting process for arranging spacers 21 on an array substrate 18 or on one of substrates 17, 18. The spacers 21 have surrounding anchoring layers 33, respectively. The manufacturing method further includes a spacer fixing process for temporarily softening the anchoring layers 33 and thereby fixing the spacers 21 to the array substrate 18, and an alignment-film forming process for applying an alignment film 27 to a surface of the array substrate 18 so that the alignment film 27 surrounds or covers the spacers 21 and the anchoring layers 33. Further included is a substrate attachment process, by which the substrates 17, 18 are attached to each other so that the liquid crystal layer 19 is enclosed between the substrates 17, 18. According to the method, the application of the alignment film 27 is made after the spacers 21 are fixed to the array substrate 18 via the anchoring layers 33. Therefore, the alignment film 27 can reliably surround or cover the spacers 21 and the anchoring layers 33. Consequently, the spacers 21 are reliably prevented from displacement, and the anchoring layers 33 are reliably prevented from seeping into the liquid crystal layer 19.

In the case that a liquid solution including a alignment film material dissolved therein and further including spacers dispersed therein is applied to the substrate, the anchoring layers covering the surfaces of the spacers may be dissolved by the highly-soluble solvent that includes a ketonic group and is included in the alignment-film solution. Further, when the solution is applied to the substrate so as to form an alignment film, the resultant alignment film may fail to cover the spacers. In contrast, according to the present embodiment, the spacers 21 arranged by the spacer setting process certainly have surrounding anchoring layers 33, and therefore can be reliably fixed on the array substrate 18. Further, the application of the alignment film 27 is made after the fixation of the spacers 21, and therefore the resultant alignment film 27 can reliably surround or cover the spacers 21 and the anchoring layers 33. Consequently, the spacers 21 can adequately provide a retention capability, without causing orientational defects.

The spacers 21 arranged by the spacer setting process have surrounding anchoring layers 33 formed of a thermoplastic material, and the anchoring layers 33 are heated by the spacer fixing process. According to the method, the spacers 21 can be readily fixed on the array substrate 18.

An ink-jet apparatus 40 is used to arrange the spacers 21 during the spacer setting process. Thereby, the spacers 21 can be arranged at predetermined positions, e.g., at the light blocking areas.

An ink-jet apparatus 40 is used to apply the alignment film 27 during the alignment-film forming process. According to the method, the application of the alignment film 27 can be achieved without generating a force to displace the spacers 21, which have been fixed on the array substrate 18 by the spacer fixing process. That is, the casual displacement of the spacers 21 can be prevented.

### Embodiment 2

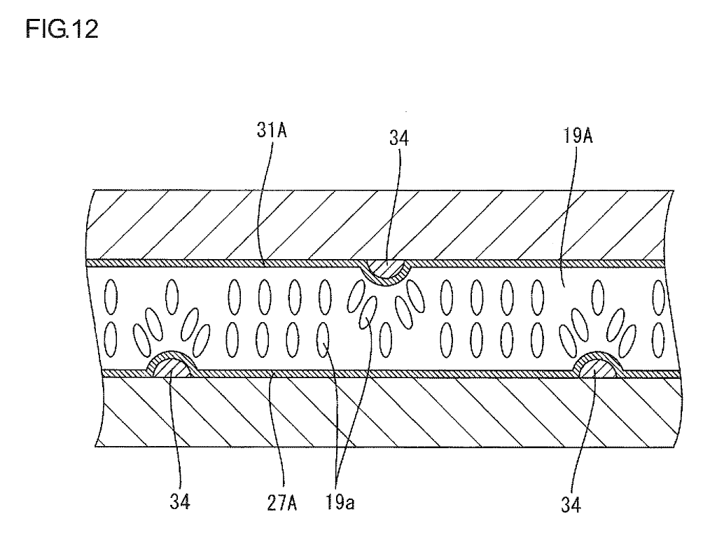

An embodiment 2 of the present invention will be explained with reference to FIG. 12. The present embodiment 2 shows a modification in which the method for orientational alignment of liquid crystal molecules is changed. In the present embodiment 2, the parts called by the same names as those of the above embodiment 1 are designated by the same symbols, but the suffix “A” is attached thereto. The redundant explanations for the constructions and operational effects will be omitted.

Referring to FIG. 12, ribs 34 (i.e., protrusions, protruding portions or uneven portions) for orientational control of the liquid crystal molecules 19a included in the liquid crystal layer 19A are provided on the surfaces of the array substrate 18A and the CF substrate 17A. The alignment films 27A, 31A are formed to cover the ribs 34, and therefore uneven portions corresponding to the ribs 34 are provided on the surfaces thereof. The alignment films 27A, 31A are formed using a selected material, so as to be able to induce the orientational alignment of the liquid crystal molecules 19a, substantially perpendicular to the surfaces thereof. For example, polyimide with a hydrophobic structure can be used as the material for the alignment films 27A, 31A. In FIG. 12, components such as the color filter, pixel electrodes and spacers are omitted.

When a voltage is not applied between the substrates 17A, 18A, the liquid crystal molecules 19a included in the liquid crystal layer 19A are oriented in the direction substantially perpendicular to the alignment films 27A, 31A. Specifically, the liquid crystal molecules 19a located at a distance from the ribs 34 are oriented in the direction substantially perpendicular to the substrates 17A, 18A, while the liquid crystal molecules 19a located close to the ribs 34 are obliquely oriented according to the shapes of the ribs 34. When a voltage is applied between the substrates 17A, 18A, the liquid crystal molecules 19a located close to the ribs 34 are first oriented in oblique directions, and the other liquid crystal molecules 19a are sequentially oriented in a similar fashion.

As explained above, according to the present embodiment, the liquid crystal molecules 19a included in the liquid crystal layer 19A are oriented in the direction substantially perpendicular to the surfaces of the alignment films 27A, 31A. Further, the ribs 34 are provided on the surfaces of the substrates 17A, 18A so as to control the orientational state of the liquid crystal molecules 19a included in the liquid crystal layer 19A. According to the construction, the alignment films 27A, 31A are not required to undergo an orientational alignment process such as a rubbing process. In the case that the alignment films 27A, 31A should undergo a rubbing process, for example, the spacers covered with the alignment film 27A or 31A may be displaced during the rubbing process. In contrast, the displacement can be prevented according to the present embodiment.

### Other Embodiments

The present invention is not limited to the embodiments explained in the above description made with reference to the drawings. The following embodiments may be included in the technical scope of the present invention, for example.

(1) In the above embodiments, the spacers are arranged on the array substrate by using an ink-jet apparatus. However, the spacers may be arranged by another method. For example, electrically-charged spacers can be arranged to be located at predetermined positions.

(2) In the above embodiments, the alignment film is applied to the array substrate by using an ink-jet apparatus. However, the alignment film may be applied by another method.

(3) In the above embodiments, a thermoplastic resin material is used for the anchoring layers of the spacers. However, the present invention can include a construction that uses another type of material such as a photo-curable resin material capable of being hardened by specified light irradiation.

(4) In the above embodiments, the spacers are arranged on the gate wiring lines corresponding to the light blocking areas. However, the present invention can include a construction in which the spacers are arranged on other light blocking areas such as the source wiring lines.

(5) In the above embodiments, the spacers are arranged at the shared light blocking areas, i.e., at the light blocking areas common to both substrates. However, the present invention can include a construction in which the spacers are arranged at nonshared light blocking areas, i.e., at the light blocking areas solely provided on one of the substrates. Further, the present invention can include a construction in which spacers are arranged at light transmitting areas.

(6) In the above embodiments, the alignment films to be subjected to an optical alignment process and the alignment films immune to an alignment process are shown, respectively. However, the present invention can include a construction in which the alignment films undergo a rubbing process and thereby a surface thereof is rubbed with a cloth by a predetermined number of repetitions so as to develop an alignment capability.

(7) In the above embodiments, the spacers are fixed to the array substrate side. However, the present invention can include a construction in which the spacers are fixed to the CF substrate side. In this case, the spacers and the anchoring layers can be covered with the alignment film provided on the CF substrate side.

(8) In the above embodiments, the manufacture of a liquid crystal panel by use of “a one-drop-fill method” is shown, in which a liquid crystal material is dropped on one of the substrates and thereafter the substrates are attached to each other. However, “a vacuum injection method” may be used instead. That is, after the substrates are attached to each other, a liquid crystal material may be injected between the substrates by vacuum injection.

(9) In the above embodiments, TFTs are used as switching elements. However, the present invention can include a construction that uses another type of switching elements than TFTs.

(10) In the above embodiments, cold cathode tubes are used as light sources of the backlight. However, the present invention can include a construction that uses another type of linear light sources than cold cathode tubes (such as hot cathode tubes), and also include a construction that uses LEDs.

(11) In the above embodiments, a television receiver as a device having a tuner is shown for illustrative purposes. However, the present invention can be applied to a display device that does not have a tuner.

(12) In the above embodiment 2, the ribs are provided as uneven portions for orientational control of the liquid crystal. However, the present invention can include a construction in which slits as uneven portions are formed in places, for example, on the pixel electrodes of the array substrate or on the counter electrode of the CF substrate. The slits can control the orientational state of the liquid crystal when an electric field is formed due to a voltage applied between the electrodes.

1. A liquid crystal panel comprising:
a pair of substrates arranged to face each other so that a gap of a predetermined size is maintained therebetween;
a liquid crystal layer enclosed between said substrates;
a spacer arranged in said liquid crystal layer, said spacer being provided to maintain the gap between said substrates;
an anchoring layer arranged to fix said spacer to one of said substrates; and
an alignment film arranged on a surface of said one of said substrates so as to surround and cover said spacer and said anchoring layer, said surface facing the other of said substrates, said alignment film being provided for orientational alignment of liquid crystal molecules included in said liquid crystal layer.

2. A liquid crystal panel as in claim 1, wherein said anchoring layer is formed of a thermoplastic material.

3. A liquid crystal panel as in claim 1, wherein said alignment film is formed of a photoreactive material so that a surface thereof becomes anisotropic by light irradiation.

4. A liquid crystal panel as in claim 1, wherein:
the liquid crystal molecules included in said liquid crystal layer are oriented in a direction substantially perpendicular to a surface of said alignment film; and
an uneven portion is provided on a surface of at least one of said substrates so as to control an orientational state of the liquid crystal molecules included in said liquid crystal layer.

5. A liquid crystal panel as in claim 1, wherein said spacer is arranged at a light blocking area on at least one of said substrates.

6. A liquid crystal display device comprising:
a liquid crystal panel as in claim 1; and
a lighting device capable of illuminating said liquid crystal panel.

7. A television receiver comprising a liquid crystal display device as in claim 6.

8. A manufacturing method of a liquid crystal panel having:
a pair of substrates arranged to face each other so that a gap of a predetermined size is maintained therebetween;
a liquid crystal layer enclosed between said pair of substrates;
a spacer arranged in said liquid crystal layer, said spacer being provided to maintain the gap between said substrates; and
an alignment film provided for orientational alignment of liquid crystal molecules included in said liquid crystal layer;
said manufacturing method comprising:
arranging said spacer on one of said substrates by a spacer setting process, said spacer having a surrounding anchoring layer;
softening said anchoring layer temporarily by a spacer fixing process, so that said spacer is fixed to said one of said substrates;
applying said alignment film to a surface of said one of said substrates by an alignment-film forming process, so that said alignment film surrounds and covers said spacer and said anchoring layer; and
attaching said substrates to each other by a substrate attachment process, so that said liquid crystal layer is enclosed between said substrates.

9. A manufacturing method of a liquid crystal panel as in claim 8, wherein:
said spacer arranged by said spacer setting process has an anchoring layer formed of a thermoplastic material as said surrounding anchoring layer; and
said anchoring layer is heated by said spacer fixing process.

10. A manufacturing method of a liquid crystal panel as in claim 8, wherein an ink-jet apparatus is used to arrange said spacer during said spacer setting process.

11. A manufacturing method of a liquid crystal panel as in claim 8, wherein an ink-jet apparatus is used to apply said alignment film during said alignment-film forming process.
